(19) United States
(12) Patent Application Publication
(10) Pub. No.: US 2010/0177090 A1
(43) Pub. Date: Jul. 15, 2010

(54) Display device

(76) Inventor: Naoaki Komiya, Yongin-City (KR)

Correspondence Address: LEE & MORSE, P.C., 3141 FAIRVIEW PARK DRIVE, SUITE 500, FALLS CHURCH, VA, 22042, US

(21) Appl. No.: 12/654,789

(22) Filed: Jan. 4, 2010

(30) Foreign Application Priority Data
Jan. 12, 2009 (KR) 10-2009-0002366

(51) Int. Cl. G06F 3/038; G09G 3/34

(52) U.S. Cl. 345/214; 345/84

(57) ABSTRACT

A display device includes a plurality of scan lines that extend in a first direction and transfer a plurality of scan signals, a plurality of data lines that extend in a second direction intersecting the first direction and transfer data signals corresponding to input video signals, a plurality of sub-pixels formed in an area defined by the plurality of scan lines and the plurality of data lines, a plurality of pixels defined by the plurality of sub-pixels, and a barrier structure corresponding to the plurality of pixels, the barrier structure including a transmitting area and a non-transmitting area, wherein at least two adjacent sub-pixels arranged in the second direction form one pixel.

### BACKGROUND OF THE INVENTION

1. Field of the Invention

Embodiments relate to a display device, and more particularly, to a display device that is capable of displaying stereoscopic images.

2. Description of the Related Art

In general, a display device displaying stereoscopic images relies on binocular parallax to display a stereoscopic image. Such a display device uses a scheme that spatially separates left and right eye images using an optical device to view stereoscopic images.

In order to display stereoscopic images on the display device, a gap between a barrier and a sub-pixel of the display panel and a width (hereinafter referred to as “pitch”) of the sub-pixel in a row direction are considered to be important conditions. Recently, as the resolution of the display device has been increased, the pitch of the sub-pixel has decreased. To realize proper stereoscopic effect, as the pitch decreases, the gap becomes narrower. However, if the gap is too narrow, there may not be sufficient space for the barrier and the display panel to be properly formed.

In order to solve the above problem, a display panel manufactured to display a portrait layout may be rotated to a landscape layout and attached to the barrier. However, in the display panel rotated to the landscape layout, a sequence of storing input image signals in a frame memory is different from a sequence of reading and outputting input video signals in the frame memory. Thereby, a screen tearing phenomenon, in which a portion of a screen displays an image of a previous frame during display of a current frame, may occur.

The above information disclosed in this Background section is only for enhancement of understanding of the background of the invention, and therefore it may contain information that does not form the prior art that is already known in this country to a person of ordinary skill in the art.

### SUMMARY OF THE INVENTION

Embodiments are therefore directed to a display device that substantially overcomes one or more of the disadvantages of the related art.

It is a feature of an embodiment to provide a display device capable of securing a distance between a barrier and a sub-pixel in order to display stereoscopic images.

At least one of the above and other features and advantages may be realized by providing a display device including a plurality of scan lines that extend in a first direction and transfer a plurality of scan signals, a plurality of data lines that extend in a second direction intersecting the first direction and transfer data signals corresponding to input video signals, a plurality of sub-pixels in an area defined by the plurality of scan lines and the plurality of data lines, a plurality of pixels defined by the plurality of sub-pixels, and a barrier structure corresponding to the plurality of pixels, the barrier structure including a transmitting area and a non-transmitting area, wherein at least two adjacent sub-pixels arranged in the second direction form one pixel.

At least one of the above and other features and advantages may be realized by providing a display device including a plurality of scan lines that extend in a first direction, a plurality of first data lines that extend in a second direction intersecting the first direction, a plurality of a second data lines that extend in the second direction, a plurality of a third data lines that extend in the second direction; a plurality of first sub-pixels in an area defined by the plurality of scan lines and the plurality of first data lines and emit light corresponding to a first color, a plurality of second sub-pixels formed in an area defined by the plurality of scan lines and the plurality of second data lines and emit light corresponding to a second color that is different from the first color, a plurality of third sub-pixels formed in an area defined by the plurality of scan lines and the plurality of third data lines and emit light corresponding to a third color that is different from the first color and the second color, a plurality of pixels that are defined by the plurality of first to third sub-pixels, and a barrier structure corresponding to the plurality of pixels, the barrier structure including a transmitting area and a non-transmitting area, wherein one pixel includes first to third sub-pixels adjacent to each other in the second direction.

At least one of the above and other features and advantages may be realized by providing a display device including a plurality of first scan lines that extend in a first direction, a plurality of second scan lines that extend in the first direction, a plurality of the third scan lines that extend in the first direction, a plurality of data lines that extend in a second direction intersecting the first direction, a plurality of first sub-pixels that are formed in an area defined by the plurality of data lines and the plurality of first data lines and emit light corresponding to a first color, a plurality of second sub-pixels that are formed in an area defined by the plurality of data lines and the plurality of second scan lines and emit light corresponding to a second color that is different from the first color; a plurality of third sub-pixels that are formed in an area defined by the plurality of data lines and the plurality of third scan lines and emit light corresponding to a third color that is different from the first color and the second color, a plurality of pixels that are defined by the plurality of first to third sub-pixels, a barrier structure corresponding to the plurality of pixels, the barrier structure including a transmitting area and a non-transmitting area, wherein one pixel includes first to third sub-pixels adjacent to each other in the second direction.

### BRIEF DESCRIPTION OF THE DRAWINGS

The above and other features and advantages will become more apparent to those of ordinary skill in the art by describing in detail exemplary embodiments with reference to the attached drawings, in which:

FIG. 1 illustrates a block diagram of an organic light emitting display device according to an exemplary embodiment of the present invention;

FIG. 2 illustrates an equivalent circuit diagram of one sub-pixel of the organic light emitting display device shown in FIG. 1;

FIG. 3 illustrates a schematic view of a barrier layer of an organic light emitting display shown in FIG. 1;

FIG. 4 illustrates a schematic view of a general display panel and a barrier layer;

FIG. 5 illustrates a relationship of a distance between the sub-pixel and the barrier layer shown in FIG. 4 and a pitch of the sub-pixel;

FIG. 6 illustrates a block diagram of a display panel of an organic light emitting display device according to a first exemplary embodiment of the present invention; and

FIG. 7 illustrates a block diagram of a display panel of an organic light emitting display device according to a second exemplary embodiment of the present invention.

### DETAILED DESCRIPTION OF THE INVENTION

Korean Patent Application No. 10-2009-0002366, filed on Jan. 12, 2009, in the Korean Intellectual Property Office, and entitled: “Display Device,” is incorporated by reference herein in its entirety.

Example embodiments will now be described more fully hereinafter with reference to the accompanying drawings; however, they may be embodied in different forms and should not be construed as limited to the embodiments set forth herein. Rather, these embodiments are provided so that this disclosure will be thorough and complete, and will fully convey the scope of the invention to those skilled in the art.

In the drawing figures, the dimensions of layers and regions may be exaggerated for clarity of illustration. It will also be understood that when a layer or element is referred to as being “on” another layer or substrate, it can be directly on the other layer or substrate, or intervening layers may also be present. Further, it will be understood that when a layer is referred to as being “under” another layer, it can be directly under, and one or more intervening layers may also be present. In addition, it will also be understood that when a layer is referred to as being “between” two layers, it can be the only layer between the two layers, or one or more intervening layers may also be present. Like reference numerals refer to like elements throughout.

In the whole specification, unless explicitly described to the contrary, the word “comprise” and variations such as “comprises” or “comprising” will be understood to imply the inclusion of stated elements but not the exclusion of any other elements.

Hereinafter, an organic light emitting display device that is one example of a display device according an exemplary embodiment of the present invention and a driving method thereof will be described.

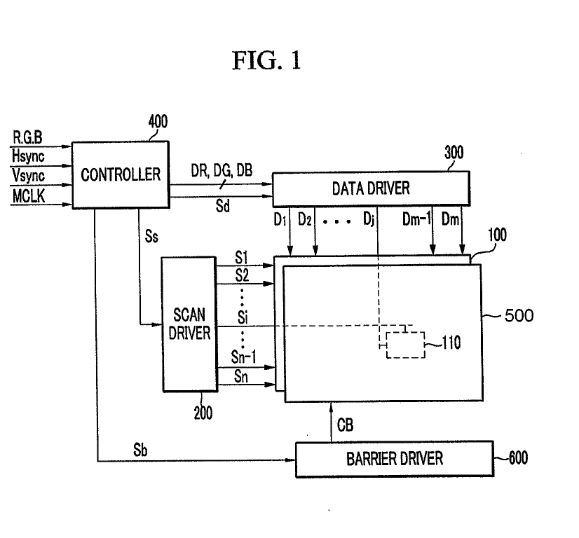

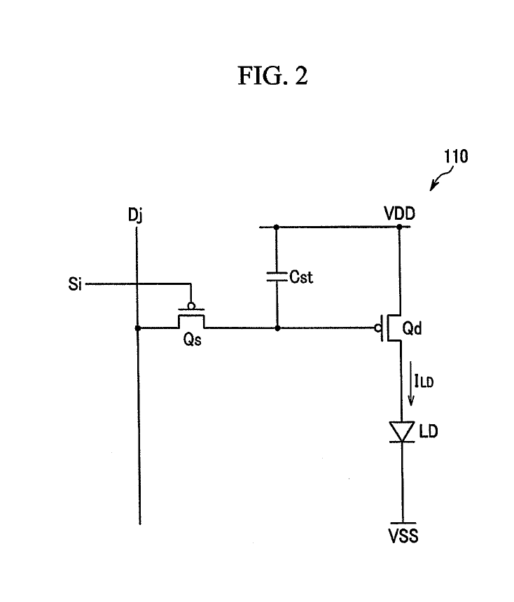

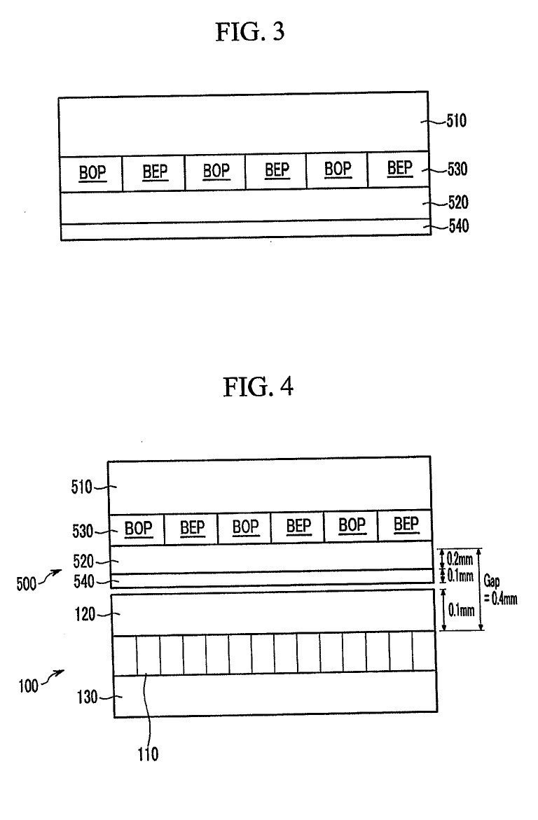

FIG. 1 illustrates a block diagram of an organic light emitting display device according to an exemplary embodiment of the present invention. FIG. 2 illustrates equivalent circuit diagram of one sub-pixel of the organic light emitting display device shown in FIG. 1. FIG. 3 illustrates a schematic view of a barrier structure of an organic light emitting display shown in FIG. 1.

As shown in FIG. 1, the organic light emitting display device is a device that can selectively display a plane image and a stereoscopic image. The organic light emitting display device may include a display panel 100, a scan driver 200, a data driver 300, a controller 400, a barrier structure 500, and a barrier driver 600.

When viewing the display panel 100 from an equivalent circuit perspective, the display panel 100 may include a plurality of signal lines S₁-Sₙ and D₁-Dₘ, a plurality of voltage lines (not shown), and a plurality of sub-pixels 110 connected thereto and arranged in a matrix form.

The signal lines S₁-Sₙ and D₁-Dₘ may include the plurality of scan lines S₁-Sₙ that transfer scan signals and a plurality of data lines D₁-Dₘ that transfer data signals. The plurality of scan lines S₁-Sₙ may extend approximately in a row direction and may be approximately parallel with each other. The plurality of data lines D₁-Dₘ may extend approximately in a column direction, may be approximately parallel with each other, and may be approximately orthogonal to the scan lines. At this time, the data signals may be voltage signals (hereinafter referred to as “data voltage”) and current signals (hereinafter referred to as “data current”) according to the type of sub-pixel 110. Hereinafter, the data voltage will be described as the data signal.

Referring to FIG. 2, each sub-pixel 110, e.g., the sub-pixel 110 connected to an i-th (i=1, 2, . . . , n) scan line Si and j-th (j=1, 2, . . . , m) data line Dⱼ, may include an organic light emitting element LD, a driving transistor Qd, a capacitor Cst, and a switching transistor Qs.

The switching transistor Qs includes a control terminal, an input terminal, and an output terminal. The control terminal may be connected to the scan line Sⱼ, the input terminal may be connected to the data line Dⱼ, and the output terminal may be connected to the driving transistor Qd. The switching transistor Qs may transfer the data signal, i.e., the data voltage transferred to the data line Dⱼ, in response to the scan signal applied to the scan line Sⱼ.

The driving transistor Qd includes a control terminal, an input terminal, and an output terminal. The control terminal may be connected to the switching transistor Qs, the input terminal maybe connected to the driving voltage Vdd, and the output terminal may be connected to the organic light emitting element LD. A current I_{LD} may vary in accordance with a voltage applied between the control terminal and the output terminal flows through the driving transistor Qd.

The capacitor Cst may be connected between the control terminal and the input terminal of the driving transistor Qd. The capacitor Cst may charge a data voltage applied to the control terminal of the driving transistor (Qd) and may maintain the data voltage after the switching transistor (Qs) is turned off.

The organic light emitting element LD may be an organic light emitting diode (OLED), and may include an anode connected to the output terminal of the driving transistor Qd and a cathode connected to a common voltage Vss. The organic light emitting element LD may display images by varying the magnitude of the output current I_{LD} according to the output current of the driving transistor Qd.

The organic light emitting element LD may emit light of one color among primary colors, e.g., red R, green G, and blue B. Desired colors may be displayed as a spatial sum or a temporal sum of these primary colors. One pixel may be formed by amalgamating three sub-pixels each having an organic light emitting element LD that respectively emits the red, green, and blue light, i.e., a red sub-pixel, a green sub-pixel, and a blue sub-pixel. Alternatively, four or more sub-pixels may form one pixel. In this case, one pixel may include a sub-pixel having an organic light emitting element LD emitting white light, improving luminance of the pixel. As a further alternative, the organic light emitting element LD of all the sub-pixels 110 may emit white light and some sub-pixels 110 may further include a color filter (not shown) that changes white light into light of any one of the primary colors.

The switching transistor Qs and the driving transistor Qd may be p-channel field effect transistors (FET) made of, e.g., amorphous silicon or polysilicon. In this case, each of the control terminal, the input terminal, and the output terminal corresponds to a gate, a source, and a drain. However, at least one of the switching transistor Qs and the driving transistor Qd may be the p-channel field effect transistor. Also, the connection relationship of the transistors Qs and Qd, the capacitor Cst, and the organic light emitting element LD may be changed.

The sub-pixel 110 shown in FIG. 2 is just one example of the sub-pixel of the organic light emitting display device. Other types of pixels, e.g., a pixel including at least two transistors or at least one capacitor, may be used. Further, as described above, a sub-pixel receiving the data current as the data signal may be used.

Referring to FIG. 3, the barrier structure 500 may include an upper substrate 510 and a lower substrate 520 that face each other, a barrier layer 530 therebetween, and a polarizer 540 on the lower substrate 520, opposite the barrier layer 530. The barrier layer 530 may include a plurality of barrier pixel rows. Each barrier pixel row may include a plurality of barrier pixels BOP and BEP arranged in a row direction.

There may be a one-to-one correspondence between the plurality of barrier pixels BOP and BEP in one barrier pixel row and the plurality of sub-pixels arranged in the row direction in one sub-pixel row of the display panel 100. Alternatively, the barrier layer 530 may include a lesser number of barrier pixel rows than the number of sub-pixel rows of the display panel 100. In this case, one barrier pixel row may correspond to a plurality of sub-pixel rows.

The barrier pixels BOP and BEP may be formed of a liquid crystal layer (not shown) injected between the two substrates 510 and 520. In this case, as illustrated in FIG. 3, the polarizer 540 may be formed only on one of the two substrates 510 and 520.

The arrangement of liquid crystal molecules of the liquid crystal layer may be changed according to the magnitude of the voltages applied between electrodes (not shown) on the two substrates 510 and 520, respectively, such that the polarization of light transmitting through the liquid crystal layer is changed. The change in polarization changes light transmitted by the polarizer 540. Thereby, when the even barrier pixel BEP is operated as an area for transmitting light, the odd barrier pixel BOP may be operated as a non-transmitting area for shielding light and, when the even barrier pixel BEP is operated as a non-transmitting area, the odd barrier pixel BOP may be operated as a transmitting area.

When the odd barrier pixel BOP is operated as the transmitting area and the even barrier pixel BEP is operated as the non-transmitting area, the odd sub-pixel of the sub-pixel row may be operated as the sub-pixel corresponding to a left-eye image of an observer (hereinafter, “sub-pixel for left eye”) and the even sub-pixel is operated as the sub-pixel corresponding to a right eye image by an observer (hereinafter, “sub-pixel for right eye”). In contrast, when the odd barrier pixel BOP is operated as the non-transmitting area and the even barrier pixel BEP may be operated as the transmitting area, the odd sub-pixel of the pixel row may be operated as the sub-pixel for the right eye and the even sub-pixel is operated as the sub-pixel for the left eye. At this time, when the right eye image projected from the sub-pixel for the right eye and the left eye image projected from the sub-pixel for the left eye are recognized by a right eye and a left eye of an observer, respectively, the observer perceives the stereoscopic effect, i.e., the image viewed appears to be an actual stereoscopic object.

Referring back to FIG. 1, the scan driver 200 is connected to the scan lines S₁-Sₙ of the display panel 100, and may sequentially apply the scan signals to the scan lines S₁-Sₙ. The scan signal may include a combination of a gate-on voltage Von that can turn on the switching transistor Qs and a gate-off voltage Voff that can turn off the switching transistor Qs. When the switching transistor Qs is a p-channel field effect transistor, the on voltage Von and the off voltage Voff are respectively a low voltage and a high voltage.

The data driver 300 is connected to the data lines D₁-Dₘ of the display panel 100, may convert image data DR, DG, and DB input from the controller 400 into data voltages, and may apply the data voltages to the data lines D₁-Dₘ.

The controller 400 may control the scan driver 200, the data driver 300, and the barrier driver 600, and may receive input video signals R, G, and B, and input control signals that control the display thereof, from the outside. The input video signal may include luminance information of each sub-pixel 110. The luminance information may include a gray scale corresponding to a defined number, for example 1024=2¹⁰, 256=2⁸ or 64=2⁶. Input control signals may include a horizontal synchronization signal Hsync, a vertical synchronization signal Vsync, a main clock signal MCLK, and the like. The input video signals R, G, and B may be any of the stereoscopic video signals, e.g., stereoscopic graphics data and point-in-time image data that are stereoscopically displayed on the plane, the plane video signal, the three-dimensional space coordinates, and the surface information of the object to be displayed. When both a plane image and a stereoscopic image are to be displayed on the display panel 100, the input video signals R, G, and B may include both the plane image signal and the stereoscopic image signal.

The controller 400 may properly process the input video signals R, G, and B in accordance with the operation conditions of the display panel 100 and the barrier structure 500 based on the input video signals R, G, and B and the input control signal to generate the scan control signal Ss, the data control signal Sd, and the barrier control signal Sb. The controller 400 may transfer the scan control signal Ss to the scan driver 200, the data control signal Sd and the processed image data DR, DG, and DB to the data driver 300, and the barrier control signal Sb to the barrier driver 600.

The barrier driver 600 may generate the barrier driving signal CB that operates the barrier structure 500 according to the barrier control signal Sb, and may transfer the generated barrier driving signal CB to the barrier structure 500.

Hereinafter, the operation of the display device will be described in detail.

The data driver 300 may receive the image data DR, DG, and DB for the sub-pixel 110 of one row according to the data control signal Sd from the controller 400, convert the image data DR, DG, and DB into the data voltage, and apply the data voltage to the corresponding data lines D₁-Dₘ.

The scan driver 200 may apply the gate-on voltage Von to the scan lines S₁-Sₙ according to the scan control signal Ss from the control 400, thus turning on the switching transistor Qs connected to the scan lines S₁-Sₙ. Thereby, the data voltage applied to the data lines D₁-Dₘ is transferred to the corresponding sub-pixel through the turned-on switching transistor Qs.

The driving transistor Qd receives the data voltage through the turned-on switching transistor Qs and emits light having strength corresponding to the output current I_{LD} that corresponds to the data voltage.

The gate-on voltage (Von) may be sequentially applied to all the scan lines S₁-Sₙ and the data voltage may be sequentially applied to all the sub-pixels 110 by repeating the above process based on one horizontal period (represented by “1H” having the same period as the horizontal synchronous signal (Hsync) and the data enable signal (DE)), thereby displaying the image corresponding to one field.

At this time, the barrier driver 600 may set the odd barrier pixel (BOP) and the even barrier pixel (BEP) of the barrier structure 500 in one field to the non-transmitting area and the transmitting area, respectively, and the odd barrier pixel (BOP) and the even barrier pixel (BEP) of the barrier structure 500 in a subsequent field to the transmitting area and the non-transmitting area, respectively. Thus, the stereoscopic image of one frame may be displayed in accordance with the barrier control signal Sb.

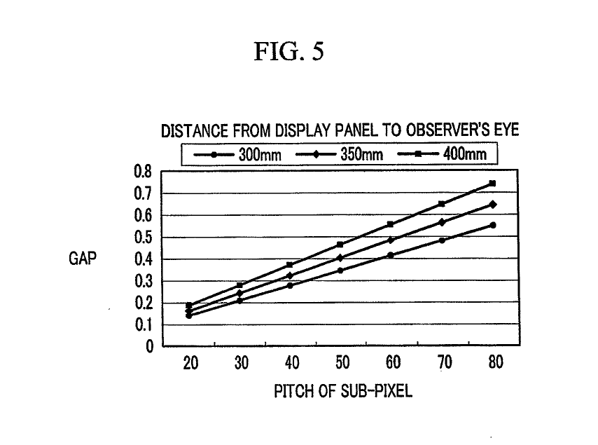

Hereinafter, the relationship between the barrier structure 500 and the sub-pixel 110 for displaying the stereoscopic image will be described in detail with reference to FIGS. 4 and 5. FIG. 4 illustrates a schematic view of the display panel 100 and the barrier structure 500. FIG. 5 illustrates a view showing a relationship of a distance between the sub-pixel and the barrier layer shown in FIG. 4 and a pitch of the sub-pixel.

Referring to FIGS. 4 and 5, the display panel 100 may include lower and upper substrates 120 and 130 that face each other, and the plurality of sub-pixels 110 may be formed between the lower and upper substrates 120 and 130. Here, the plurality of sub-pixels 110 for each pixel, i.e., the red sub-pixel, the green sub-pixel, and the blue-pixel, are alternately arranged in a row direction so that the red, green, and blue sub-pixels adjacent to each other in a row direction form one pixel.

As can be seen in FIG. 5, for a given sub-pixel pitch, a corresponding gap between the sub-pixel 110 and the barrier layer 530 is needed for the stereoscopic image to be properly viewed, and vice versa, i.e., for a given gap, a particular sub-pixel pitch would be needed. For example, in order to display the stereoscopic image, assuming that a distance from the display panel 100 to the observer's eyes is 350 mm, the gap between the sub-pixel 110 and the barrier structure 500 is 0.4 mm so that the pitch of the sub-pixel 110 becomes 47 μm. If the thickness of the polarizer 540 is set to 0.1 mm and the thickness of the lower substrate 520 is set to 0.2 mm in the barrier structure 500, the thickness of the upper substrate 120 of the display panel 100 should be 0.1 mm.

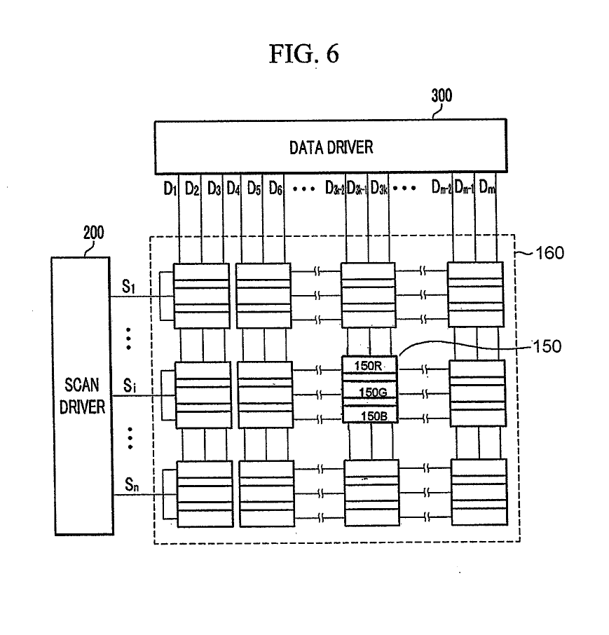

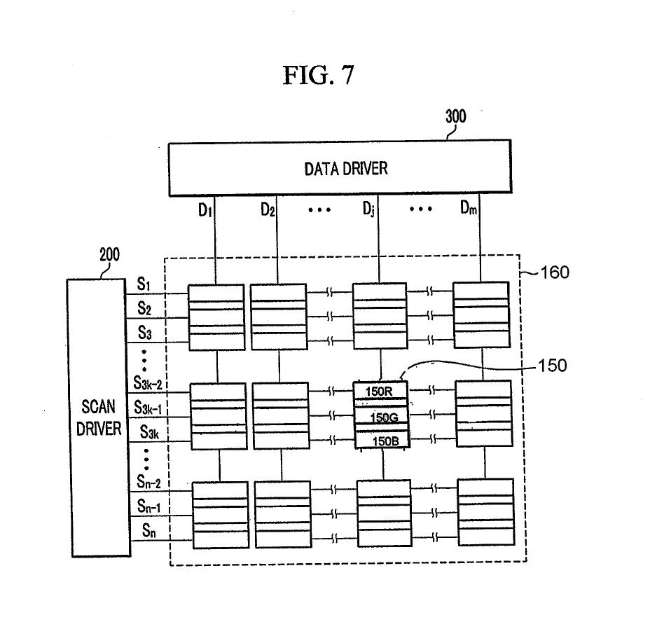

Since it is difficult to form the upper substrate 120 to have the above thickness, the pitch of the sub-pixel 110 should be increased, to allow use of a larger gap, i.e., a thicker upper substrate 120. However, increasing the pitch may reduce resolution. In order to solve the problem, in an exemplary embodiment, sub-pixels may be disposed in a display panel as shown in FIGS. 6 and 7. As the barrier structure 500 may be the same, details thereof will not be repeated; and the barrier structure 500 discussed above may be employed with either embodiment illustrated in FIGS. 6 and 7.

FIG. 6 illustrates a view of a display panel of the organic light emitting display device according to a first exemplary embodiment of the present invention.

As shown in FIG. 6, a plurality of sub-pixels 150_{R}, 150_{G}, and 150_{B} may be alternately arranged in a direction where the data lines D₁ to Dₘ of the display panel 100 extend, i.e., a column direction, and the red, green, and blue sub-pixels 150_{R}, 150_{G}, and 150_{B} adjacent each other may form one pixel 150. The three sub-pixels 150_{R}, 150_{G}, and 150_{B} of one pixel 150 may be connected to the same scan line Si and different data lines D₃ₖ₋₂, D₃ₖ₋₁, and D₃ₖ (k=1, 2, . . . n/3). In other words, the red sub-pixel 150_{R} may be connected to a 3k−2-th data line D₃ₖ₋₂, the green sub-pixel 150_{G} may be connected to a 3k−1-th data line (D₃ₖ₋₁), and the blue sub-pixel 150_{B} may be connected to a 3k-th data line D₃ₖ. These three sub-pixels 150_{R}, 150_{G}, and 150_{B} may be commonly connected to the same scan line Sᵢ. Thereby, when the scan signal having the gate-on voltage Von is applied to the i-th scan line Sᵢ, the data driver 300 applies the data voltage corresponding to the red, green, and blue image data DR, DG, and DB to the data lines D₃ₖ₋₂, D₃ₖ₋₁, and D₃ₖ, respectively.

In this case, one barrier pixel row of the barrier layer 530 may be formed to correspond to one pixel row of the display panel 100, i.e., the plurality of pixels 150 arranged in a row direction, and each barrier pixel (BEP/BOP) may be formed to correspond to one pixel 150.

FIG. 7 illustrates a view of a display panel of the organic light emitting display device according to a second exemplary embodiment of the present invention.

As shown in FIG. 7, three sub-pixels 150_{R}, 150_{G}, and 150_{B} of one pixel 150 may be connected to the different scan lines S₃ₖ₋₂, S₃ₖ₋₁, and S₃ₖ, and to the same data line Dⱼ (k=1, 2, . . . , n/3). In other words, the red sub-pixel 150_{R} may be connected to the 3k−2-th scan line S₃ₖ₋₂, the green sub-pixel 150_{G} may be connected to the 3k−1-th scan line S₃ₖ₋₁, and the blue sub-pixel 150_{B} may be connected to the 3k-th scan line S₃ₖ. Further, these three sub-pixels 150_{R}, 150_{G}, and 150_{B} may be commonly connected to the same data line Dⱼ. First, when the scan signal having the gate-on voltage Von is applied to the 3k−2-th scan line S₃ₖ₋₂, the data driver 300 applies the data voltage corresponding to the red image data DR to the red sub-pixel 150_{R} through the data line Dⱼ. Next, when the scan signal having the gate-On voltage Von is applied to the 3k−1-th scan line S₃ₖ₋₁, the data driver 300 applies the data voltage corresponding to the green image data DG to the green sub-pixel 150_{G} through the data line Dⱼ. When the scan signal having the gate-on voltage Von is applied to the 3k-th scan line (S₃ₖ), the data driver 300 applies the data voltage corresponding to the blue image data DB to the blue sub-pixel 150_{B} through the data line Dⱼ. In other words, when the scan signals having the gate-on voltage Von are sequentially applied to the scan lines S₃ₖ₋₂, S₃ₖ₋₁, and S₃ₖ, the data driver 300 sequentially applies the data voltage to the three sub-pixels 150_{R}, 150_{G}, and 150_{B}, respectively, through the same data line Dⱼ.

The gap between the barrier layer 530 and the pixel 150 for displaying the stereoscopic image may be sufficiently large to accommodate both the barrier structure 500 and the display panel 160 by arranging the sub-pixels 150_{R}, 150_{G}, and 150_{B} in the display panel 160 according to one of the first and second exemplary embodiments. In other words, in accordance with embodiments, since the pitch of the sub-pixels 150_{R}, 150_{G}, and 150_{B}, in the row direction may be increased without decreasing resolution, the gap may be increased, allowing sufficient space for the barrier structure and the display panel 160 to be properly formed. Finally, storage of image signals and reading and outputting of video signals may be realized in a same sequence.

Although the organic light emitting display device as an example of the display device in the exemplary embodiment of the present invention display device is described, the present invention is not limited thereto. The present invention can also be applied to other display devices such as a plasma display, a liquid crystal layer, a field emission display, etc.

Exemplary embodiments of the present invention have been disclosed herein, and although specific terms are employed, they are used and are to be interpreted in a generic and descriptive sense only and not for purpose of limitation. Accordingly, it will be understood by those of ordinary skill in the art that various changes in form and details may be made without departing from the spirit and scope of the present invention as set forth in the following claims.

What is claimed is:

1. A display device, comprising:
a plurality of scan lines that extend in a first direction and transfer a plurality of scan signals;
a plurality of data lines that extend in a second direction intersecting the first direction and transfer data signals corresponding to input video signals;
a plurality of sub-pixels formed in an area defined by the plurality of scan lines and the plurality of data lines;
a plurality of pixels defined by the plurality of sub-pixels; and
a barrier structure corresponding to the plurality of pixels, the barrier structure including a transmitting area and a non-transmitting area,
wherein at least two adjacent sub-pixels arranged in the second direction form one pixel.

2. The display device as claimed in claim 1, wherein he at least two adjacent sub-pixels are connected to a same scan line and different data lines, respectively.

3. The display device as claimed in claim 1, wherein the at least two adjacent sub-pixels are connected to a same data line and different scan lines, respectively.

4. The display device as claimed in claim 1, wherein
the at least two adjacent sub-pixels include:
a first sub-pixel adapted to emit a first color;
a second sub-pixel adapted to emit a second color that is different from the first color; and
a third sub-pixel adapted to emit a third color that is different from the first and second colors,
wherein the first to third sub-pixels are alternately arranged in the second direction.

5. The display device of any one as claimed in claims 1, wherein:
the barrier structure includes at least one barrier pixel row,
the at least one barrier pixel row includes a plurality of barrier pixels arranged in the first direction, and
the plurality of barrier pixels correspond to the plurality of pixels arranged in the first direction.

6. The display device as claimed in claim 5, wherein each of the plurality of barrier pixels is set as one of the transmitting area and the non-transmitting area, the transmitting and non-transmitting areas being alternately arranged in the first direction.

7. The display device as claimed in claim 1, wherein:
the plurality of data lines includes,
a plurality of first data lines that extend in the second direction,
a plurality of second data lines that extend in the second direction, and
a plurality of third data lines that extend in the second direction;
the plurality of sub-pixels includes,
a plurality of first sub-pixels in an area defined by the plurality of scan lines and the plurality of first data lines, the plurality of first sub-pixels being adapted to emit light corresponding to a first color,
a plurality of second sub-pixels in an area defined by the plurality of scan lines and the plurality of second data lines, the plurality of second sub-pixels being adapted to emit light corresponding to a second color, different from the first color, and
a plurality of third sub-pixels in an area defined by the plurality of scan lines and the plurality of third data lines, the plurality of third sub-pixels being adapted to emit light corresponding to a third color that is different from the first color and the second color;
the plurality of pixels are defined by the plurality of first to third sub-pixels; and
one pixel includes first to third sub-pixels adjacent to each other in the second direction.

8. The display device as claimed in claim 7, wherein the first to third sub-pixels are alternately arranged in the second direction.

9. The display device as claimed in claim 7, wherein the first to third sub-pixels adjacent to each other in the second direction are connected to the same scan line.

10. The display device of any one as claimed in claim 7, wherein:
the barrier structure includes at least one barrier pixel row,
the at least one barrier pixel row includes a plurality of barrier pixels arranged in the first direction, and
the plurality of barrier pixels correspond to the plurality of pixels arranged in the first direction.

11. The display device as claimed in claim 1, wherein:
the plurality of scan lines includes,
a plurality of first scan lines that extend in the first direction,
a plurality of second scan lines that extend in the first direction, and
a plurality of third scan lines that extend in the first direction;
the plurality of sub-pixels includes,
a plurality of first sub-pixels in an area defined by the plurality of first scan lines and the plurality of data lines, the plurality of first sub-pixels being adapted to emit light corresponding to a first color,
a plurality of second sub-pixels in an area defined by the plurality of second scan lines and the plurality of data lines, the plurality of second sub-pixels being adapted to emit light corresponding to a second color, different from the first color, and
a plurality of third sub-pixels in an area defined by the plurality of third scan lines and the plurality of data lines, the plurality of third sub-pixels being adapted to emit light corresponding to a third color that is different from the first color and the second color;
the plurality of pixels are defined by the plurality of first to third sub-pixels; and
one pixel includes first to third sub-pixels adjacent to each other in the second direction.

12. The display device as claimed in claim 11, wherein the first to third sub-pixels are alternately arranged in the second direction.

13. The display device as claimed in claim 11, wherein the first to third sub-pixels adjacent to each other in the second direction are connected to the same data line.

14. The display device of any one as claimed in claim 11, wherein:
the barrier structure includes at least one barrier pixel row,
the at least one barrier pixel row includes a plurality of barrier pixels arranged in the first direction, and
the plurality of barrier pixels correspond to the plurality of pixels arranged in the first direction.
